(19) United States
(12) Patent Application Publication
(10) Pub. No.: US 2012/0098649 A1
(43) Pub. Date: Apr. 26, 2012

(54) ELECTRONIC OPEN-LOOP OR CLOSED-LOOP CONTROL DEVICE FOR ELECTRICALLY POWERED FURNITURE

(76) Inventors: Mathias GRIMM, Altach (AT); Thomas Taimler, Hochst (AT)

(21) Appl. No.: 13/339,795

(22) Filed: Dec. 29, 2011

Related U.S. Application Data
(63) Continuation of application No. PCT/AT2010/000220, filed on Jun. 16, 2010.

(30) Foreign Application Priority Data
Jun. 30, 2009 (AT) A 1014/2009

(51) Int. Cl. G05B 11/01

(52) U.S. Cl. 340/12.5

(57) ABSTRACT

An open-loop or closed-loop control device for electric components which are arranged in or on a piece of furniture or a part of a piece of furniture, having:
a microprocessor, which carries out the open-loop and/or closed-loop control functions during operation, and an interface for wire-free communication between the open-loop or closed-loop control device and the outside world, wherein the microprocessor and the interface are arranged in a common housing and are arranged either on printed circuit boards which are detachably attached to one another or on printed circuit boards which are arranged separately from one another in or on the open-loop or closed-loop control device.

This applications is a Continuation of International application No. PCT/AT2010/000220, filed Jun. 16, 2010, the entire disclosure of which is incorporated herein by reference.

The present invention concerns an open-loop or closed-loop control device for electric components arranged in or on an article of furniture or a part of an article of furniture, comprising:
a microprocessor which in operation performs the open-loop or closed-loop control function respectively, and
an interface for wireless communication of the open-loop or closed-loop control device with the outside world.

In recent years electric components are increasingly used in the furniture industry, which for example serve to drive parts of articles of furniture movably mounted in or on an article of furniture or to light articles of furniture or parts thereof. Open-loop or closed-loop control devices are provided for open-loop or closed-loop control of the corresponding functions of the electric components, which devices usually have a microprocessor which is arranged on a printed circuit board and which in operation of the electric component performs the open-loop or closed-loop control functions. To permit communication of the open-loop or closed-loop control device with the outside world there is usually at least one interface which for example can be adapted to provide a wireless communication.

In the state of the art the microprocessor which performs the open-loop or closed-loop control functions respectively and the interface are arranged on a common printed circuit board. That is of a correspondingly large design configuration and there is the additional problem that, when changing either the microprocessor or the interface, it is necessary to also have the respective other component re-classified in accordance with the respective national radio directives, which is linked to considerable costs.

Thus for example DE 43 12 613 A1 discloses an open-loop control device for electric components having a processor and an interface for wireless communication with the outside world. In that case the microprocessor and the interface are disposed in their respective own housings, which at any event results in increased structural sizes.

The object of the invention is to provide an open-loop or closed-loop control device of the general kind set forth, which does not suffer from the above-discussed problems.

That is achieved by an open-loop or closed-loop control device having the features of claim 1.

That solution has a series of advantages over the state of the art.

If a change is made only at one of the printed circuit boards (hereinafter the printed circuit boards equipped with electronic components and lines are sometimes also referred to as the ‘print’), there is no need to re-certify the other part. That gives a considerable cost advantage in the event of changes to the electronics.
Due to the modular structure of the microprocessor and interface, it is possible to use one and the same interface in open-loop or closed loop control devices for different electric components. Possible electric components are for example electric furniture drives and electric lighting arrangements for articles of furniture or parts thereof.
Due to the provision of a second printed circuit board an additional digital output is available. That is particularly advantageous for applications which do not themselves have any microprocessor (for example lighting) as that affords a digital output with which the application can be open-loop or closed-loop controlled.
Due to the necessary component mounting surface area being divided to two printed circuit boards the space requirement is reduced as it is possible to provide for space utilisation on various planes (heightwise displacement, stack height) or in any positioned relationship with each other.
Due to the microprocessor and the interface for wireless communication being disposed in one and the same housing, that permits an extremely compact structural shape.

By virtue of the interface it is not only possible to have the microprocessor of the open-loop or closed-loop control device communicate with individual electric components, but it is also possible to have different electric components communicate with each other by way of that interface.

The releasable fixing of the printed circuit boards to each other can for example be effected in such a way that a so-called ‘board-to-board connector’ is used.

The interface itself is generally also equipped with a microprocessor. Communication of the microprocessors arranged on different printed circuit boards with each other can be implemented by way of an SPI interface (databus) and additional DIOs (digital input/outputs).

It is preferably provided that the interface is in the form of a radio interface.

Further advantages and details of the invention will be apparent from the Figures and the related specific description.

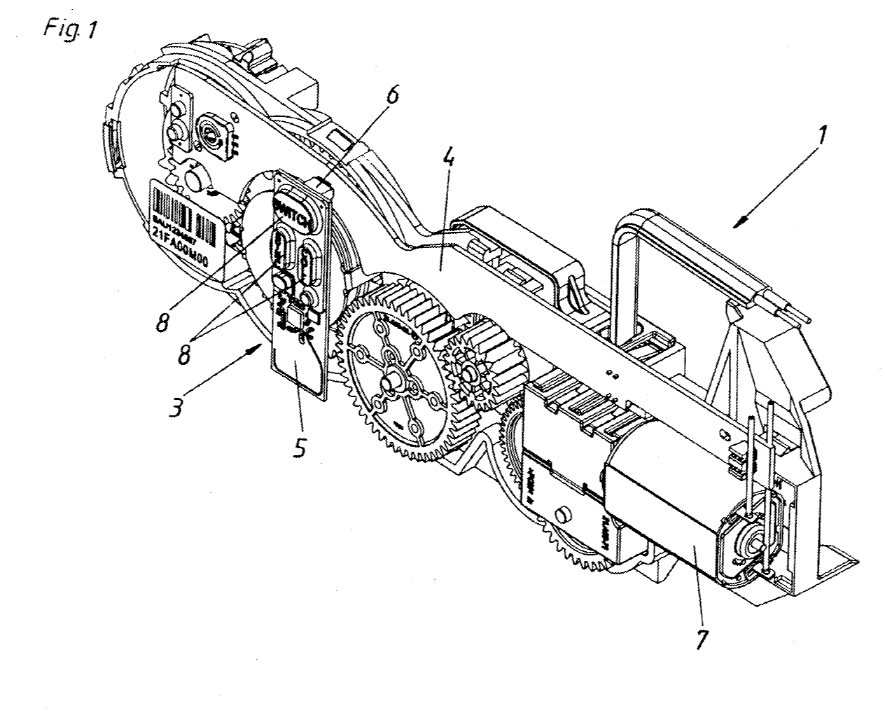

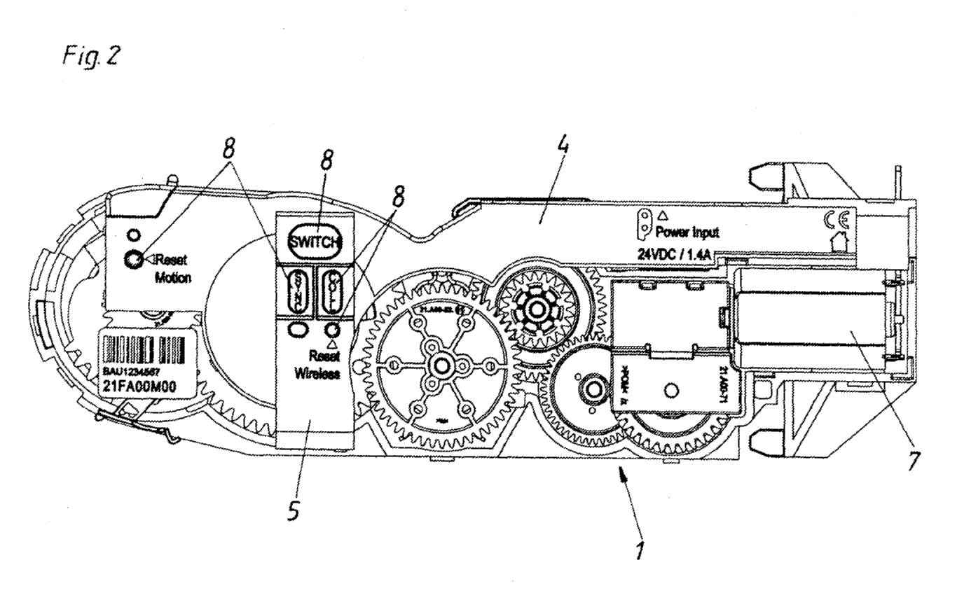

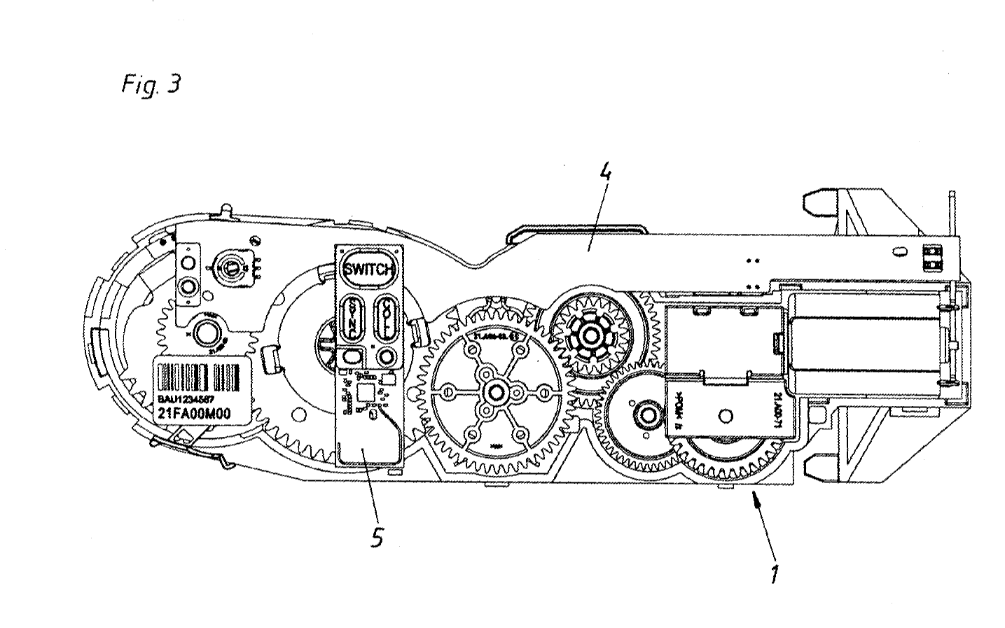

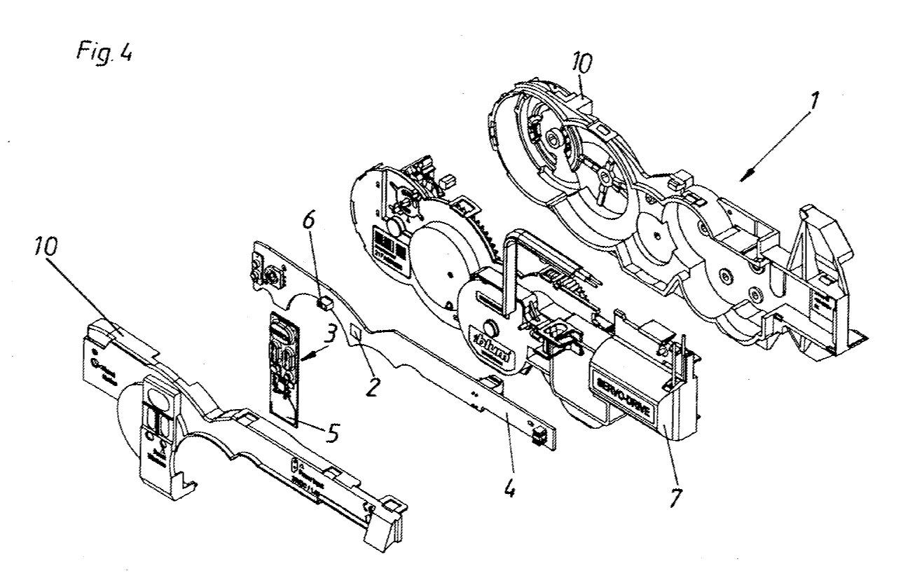

In that respect FIGS. 1 through 4 show various views of an embodiment of the invention with an electric component in the form of a flap actuating drive:

The electric component has been denoted by reference 1. The electric component 1 is in the form of a furniture drive. Apart from the specific configuration of the printed circuit boards 4, 5 the furniture drive corresponds to the state of the art and therefore does not have to be described in detail.

What is essential for the invention is the fact that an interface 3 which here is in the form of a radio interface is arranged on a printed circuit board 5 provided separately from a printed circuit board 4 in the form of a motherboard and the interface 3, the microprocessor 2 and the printed circuit boards 4 and 5 are disposed in one and the same housing. The printed circuit boards 4, 5 are both connected together by way of a contact portion 6. The power supply for the interface 3 is effected here by way of the contact portion 6 and the print 4 in the form of a motherboard. Alternatively the power supply can also be effected separately from the mechanical fixing or there can be provided a separate power supply for the printed circuit board 5.

FIG. 1 in particular shows the electric motor 7 which ultimately drives the part of the article of furniture (flap) which is not shown here. Various operating buttons 8 can be seen on the print 5, which permit manual access by the operator to the interface 3 or the microprocessor 2 of the motherboard. The printed circuit board 4 is also equipped with such an operating button 8.

1. A Device, comprising:
an open-loop or closed-loop control device for electric components arranged in or on an article of furniture or a part of an article of furniture, comprising:
a microprocessor which in operation performs the open-loop or closed-loop control function respectively, and
an interface for wireless communication of the open-loop or closed-loop control device with the outside world,
wherein the said microprocessor and the said interface are arranged in a common housing and are arranged either on printed circuit boards which are releasably fixed to each other or are arranged on printed circuit boards which are arranged separately from each other in or on the said open-loop or closed-loop control device.

2. The device according to claim 1, wherein the said interface is in the form of a radio interface.
